(19) United States
(12) Patent Application Publication
(10) Pub. No.: US 2011/0031719 A1
(43) Pub. Date: Feb. 10, 2011

(54) TOW BALL

(76) Inventor: ATHAN LEKKAS, North Adelaide (AU)

Correspondence Address: Irvine M. Weiner;Weiner & Burt, P.C., P.O. Box 186, 635 N. US-23, Harrisville, MI, 48740, US

(21) Appl. No.: 12/536,770

(22) Filed: Aug. 6, 2009

(51) Int. Cl. B60D 1/06

(52) U.S. Cl. 280/511; 280/493

(57) ABSTRACT

The present invention relates to a tow ball device adapted to connection to a tow bar of a vehicle having a substantially horizontal surface and a vertical aperture, the tow ball device including a solid ball with a shaft extending to a flange, the flange including an underside surface adapted to abut with the tow bar horizontal surface, and at least two upright, parallel flat surfaces to provide an engagement surface for a gripping tool above the tow bar. The tow ball device further includes a threaded shaft extending downwardly from the flange through said tow bar aperture, and a correspondingly threaded nut adapted for engagement with the threaded shaft below the tow bar when the flange is rotated using the gripping tool.

### FIELD OF THE INVENTION

The present invention relates to a tow ball and, in particular, to a ball with parallel flattened edges on the flange, the flat edges of the flange assisting not only in adjustment of the ball but also installation and removal to the tow bar of a vehicle.

### BACKGROUND OF THE INVENTION

There exist today many tow balls and similar apparatus that aim to facilitate the attachment of a trailer to a vehicle. However, a problem arises when trying to attach, remove or adjust the tightness of the ball onto the tow bar to which it is attached.

The first of these is that in other ball mounts, the only method of adjusting it is using a wrench on the nut on the underside of the bar. That at times may be physically challenging when trying to access the underside of the tow bar and requires the user to support the wrench in position whilst trying to rotate it.

A further problem is that when tow balls are used and adjusted on painted tow bars, the adjustment often leads to scratching of the paint.

It is therefore the object of this invention to overcome at least some of the above-mentioned problems or provide the public with a useful alternative.

### SUMMARY OF THE INVENTION

Therefore, in one form of the invention there is proposed a tow ball device including:
a solid ball with a shaft extending to a flange along a common longitudinal axis, said flange including at least two upright, parallel flat surfaces to provide an engagement surface for a gripping tool;
a threaded shaft extending downwardly from the flange along said longitudinal axis; and
a correspondingly threaded nut adapted for engagement with said threaded shaft.

Preferably said tow ball device further includes a spring locking annular washer through which said threaded shaft is adapted to extend, said washer being disposed between the flange and the nut.

In preference said flat surfaces are at least 10 mm in length.

In preference the diameter of the flange is of the same order as the diameter of the ball.

Preferably said solid ball, shaft, flange, threaded shaft and nut are made from steel.

Preferably said ball, shaft and flange are integrally formed and shaped from a single piece of material.

In preference said ball device is made to conform to Australian standard 4177.2.

In a further form of the invention there is proposed a tow bar assembly for a vehicle, said tow bar assembly including:
a tow bar including a substantially horizontal surface and an aperture extending vertically there through;
a tow ball device including a solid ball with a shaft extending to a flange along a common longitudinal axis, said flange including an underside surface adapted to abut with said tow bar horizontal surface, and at least two upright, parallel flat surfaces to provide an engagement surface for a gripping tool above said tow bar, said tow ball device further including a threaded shaft extending downwardly from the flange along said longitudinal axis adapted for insertion through said tow bar aperture, and a correspondingly threaded nut adapted for engagement with said threaded shaft below said tow bar when said flange is rotated.

Preferably said tow ball device further includes a spring locking annular washer through which said threaded shaft is adapted to extend, said washer being disposed between the flange and the nut.

In preference said flat surfaces are at least 10 mm in length.

Preferably the diameter of the flange is of the same order as the diameter of the ball.

Preferably said solid ball, shaft, flange, threaded shaft and nut are made from steel.

In preference said ball, shaft and flange are integrally formed and shaped from a single piece of material.

### BRIEF DESCRIPTION OF THE DRAWINGS

FIG. 1 illustrates a side view of a two ball as per the present invention; and

FIG. 2 illustrates a perspective view of the tow ball of FIG. 1.

### DESCRIPTION OF THE PREFERRED EMBODIMENT

The following detailed description refers to the accompanying drawings. Although the description includes exemplary embodiments, other embodiments are possible, and changes may be made to the embodiments described without parting from the spirit and scope of the invention. Wherever possible, the same reference numbers will be used throughout the drawings and the following description to refer to the same and like parts.

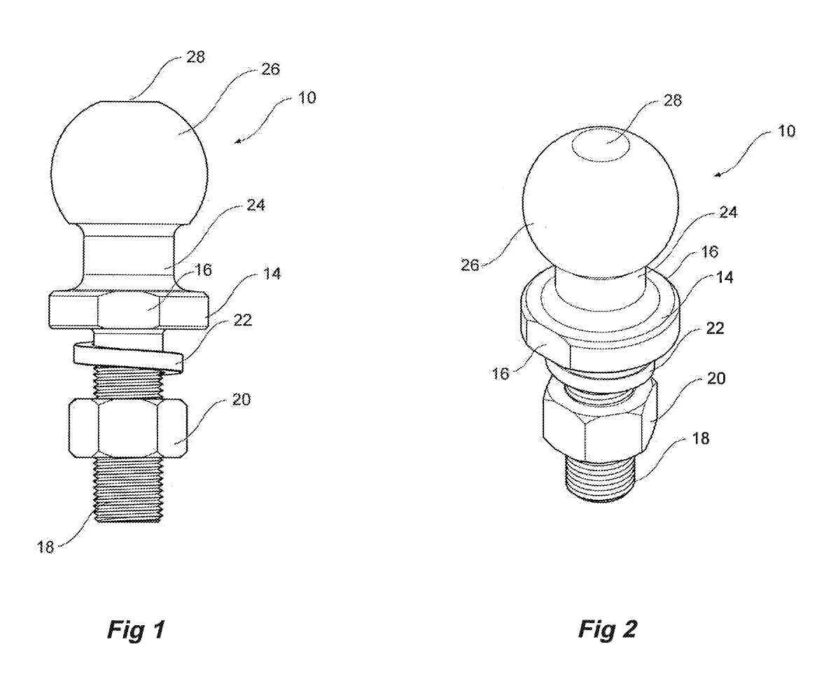

Turning now to the drawings in detail there is shown in FIGS. 1-2 a tow ball 10 adapted to be attached to a tow bar (not shown) as is well known in the field. The tow ball 10 includes a metal flange 14 with a central screw thread or shank 18 extending from the base of the flange 14 onto which a nut 20 is threaded. Above the nut 20 is a spring lock washer 22 also threaded onto the screw thread 18.

A solid metal shaft 24 extends up from the flange 14 and terminates in a solid metal sphere 26 having a flattened top face 28. The flange 14 comprises two parallel flattened gripping surfaces 16 to facilitate the use of a spanner (not shown) or other suitable wrench-type tool. The skilled addressee would realise that the shank 18 is adapted to be inserted through a vertical aperture (not shown) in the tow bar of a vehicle and locked to the tow bar on the lower side by tightening of the nut 20 against the washer 22.

In having flattened surfaces associated with the flange 14 above the tow bar, one is able to grip and rotate the flange much more easily than say having to grip and rotate the lower nut as is required using conventional tow balls. The rotating tool (not shown) can simply rest above the tow bar during rotation and therefore does not require additional support by the user. The thread of the shank 18 is a helical type thread which is configured so that when the flange 14 is rotated it draws the nut 20 upwards towards the tow bar and thereby compressing the washer 22. The flat, smooth lower surface of the flange, in combination with the use of the spring washer 22 beneath the tow bar, ensures there is little to no scratching or indentation made to the tow bar during rotation of the flange.

The tow ball is typically manufactured from a single piece of stainless steel or chrome alloy to allow for maximum strength. In other words, the flange 14, shaft 24 and sphere 26 are integrally formed.

It is to be understood that the means by which the flange part is to be gripped is not intended to be limited to the embodiment shown. For example, in an alternate embodiment which is not shown, the flange 14 could have a ridge cut into it instead of the two parallel flattened edges 16 to facilitate the use of a spanner on the tow ball. In another alternate embodiment, the flange 14 could have multiple sets of parallel flattened edges, forming for example a square, a hexagon, or an octagon, to facilitate the use of a spanner.

In so far as the dimensions of the device are concerned, this is dependent on the regulations for tow ball dimensions in the region it is being sold. In Australia it is envisaged that the ball 26 is 50 mm in diameter to conform to Australian standard 4177.2 and the thread 18 is 20 mm in diameter and 65 mm in length, for maximum strength and reliability. The flange 14 would be approximately 55 mm in diameter at the rounded edges, and approximately 43 mm at the parallel flattened edges 16.

Further advantages and improvements may very well be made to the present invention without deviating from its scope. Although the invention has been shown and described in what is conceived to be the most practical and preferred embodiment, it is recognised that departures may be made from within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A tow ball device including:
a solid ball with a shaft extending to a flange along a common longitudinal axis, said flange including at least two upright, parallel flat surfaces to provide an engagement surface for a gripping tool;
a threaded shaft extending downwardly from the flange along said longitudinal axis; and
a correspondingly threaded nut adapted for engagement with said threaded shaft.

2. A tow ball device according to claim 1 wherein said tow ball device further includes a spring locking annular washer through which said threaded shaft is adapted to extend, said washer being disposed between the flange and the nut.

3. A tow ball device according to claim 1 wherein said flat surfaces are at least 10 mm in length.

4. A tow ball device according to claim 1 wherein the diameter of the flange is of the same order as the diameter of the ball.

5. A tow ball device according to claim 1 wherein said solid ball, shaft, flange, threaded shaft and nut are made from steel.

6. A tow ball device according to claim 1 wherein said ball, shaft and flange are integrally formed and shaped from a single piece of material.

7. A tow ball device according to claim 1 wherein said ball device is made to conform to Australian standard 4177.2.

8. A tow bar assembly for a vehicle, said tow bar assembly including:
a tow bar including a substantially horizontal surface and an aperture extending vertically there through;
a tow ball device including a solid ball with a shaft extending to a flange along a common longitudinal axis, said flange including an underside surface adapted to abut with said tow bar horizontal surface, and at least two upright, parallel flat surfaces to provide an engagement surface for a gripping tool above said tow bar, said tow ball device further including a threaded shaft extending downwardly from the flange along said longitudinal axis adapted for insertion through said tow bar aperture, and a correspondingly threaded nut adapted for engagement with said threaded shaft below said tow bar when said flange is rotated.

9. A tow ball device according to claim 8 wherein said tow ball device further includes a spring locking annular washer through which said threaded shaft is adapted to extend, said washer being disposed between the flange and the nut.

10. A tow ball device according to claim 8 wherein said flat surfaces are at least 10 mm in length.

11. A tow ball device according to claim 8 wherein the diameter of the flange is of the same order as the diameter of the ball.

12. A tow ball device according to claim 8 wherein said solid ball, shaft, flange, threaded shaft and nut are made from steel.

13. A tow ball device according to claim 8 wherein said ball, shaft and flange are integrally formed and shaped from a single piece of material.
